(19) United States
(12) Patent Application Publication
(10) Pub. No.: US 2024/0066983 A1
(43) Pub. Date: Feb. 29, 2024

(54) Agricultural Vehicle

(71) Applicant: Stewart Holliday, Phoenix, AZ (US)

(72) Inventor: Stewart Holliday, Phoenix, AZ (US)

(21) Appl. No.: 17/898,804

(22) Filed: Aug. 30, 2022

(51) Int. Cl. B60K 26/02; B60K 1/04; B60N 2/04; B60N 2/38; B62D 1/12

(52) U.S. Cl. CPC B60K 26/02; B60K 1/04; B60N 2/04; B60N 2/38; B62D 1/12; B60K 2001/0416; B60K 2026/025

(57) ABSTRACT

An agricultural vehicle is disclosed having a frame with substantially parallel first and second spaced apart side rails extending substantially the length of the frame. First and second cross members extend between said spaced apart side rails in spaced apart relation to each other. The first cross member is equipped with at least one wheel pivotally attached thereto. The second cross member is attached at substantially the rear portion of said frame. The second cross member has two drive wheels rotatably attached thereto and a drive unit mounted on said chassis at said rear portion and independently drivably connected to each drive wheel. First and second drive unit controllers are mounted on different side rails substantially proximal to the front portion of said frame and operable by an operator seated in an operator seat mounted to the frame.

### TECHNICAL FIELD

The disclosure relates to a powered agricultural vehicles for tending and harvesting berries and other low growing vegetables. There is a need for an inexpensive vehicle to facilitate tending of berries and low growing vegetable as well as increase the rate and speed of harvesting berries, like strawberries, as well as other low growing vegetable that is easy to operate and reduces user fatigue and injury.

Whyte, U.S. Pat. No. 4,395,186 discloses a powered vehicle for tending low-growing vegetation. The vehicle has a frame with intersecting cross-braces; a platform mounted to the frame having an engine mounted thereupon and front and rear center swing tubes having a torsion bar spring suspension and a double articulated steering system. The vehicle further has four legs each adjustably mounted within one of the swing tubes having a motor connected by hydraulic lines to the engine and supporting a wheel and tire. The operator is in a prone position in the vehicle face down working to tend to crop. Steering is accomplished by a double articulated steering assembly with a steering arm attached at a front pivot clamp and a steering pressure cylinder connected by a hydraulic line to the engine of the vehicle. The vehicle has adjustable wheel span and a conveyor to transport picked berries etc., to a storage bin carried by the vehicle. An occupant cover is provided for inclement weather.

Johansen, U.S. Pat. No. 4,526,248 discloses a motorized cart for berry picking, weeding and the like. The cart consist of a wheeled frame on which a pad is provided which is adjustable to the contours of the human body. The cart as described depicts a human in a facedown prone position. Attached to the frame is a head support means which provides an unobstructed downward view for the berry picker. A support rack for berry baskets and crates is secured to the sides of the cart, and the cart can be provided with a roof so that picking and weeding can be performed in inclement weather. The wheel frame can be articulated in the center and steered in front, and the cart is provided with an electric motor, the gas and brakes being operated with a foot pedal presumably while the operator is in the prone position.

Faucheux, U.S. Pat. No. 2,825,273 depict an agricultural machine for thinning out plant sown in a line. The vehicle is constructed to be towed as, for example, by chains. The operator, or operators, are prone face down in the vehicle and thin plants as the vehicle is towed down the plant row line.

Olson, U.S. Pat. No. 3,037,570 discloses a vehicle controlled by the harvest worker. The vehicle is adapted to transport a berry picker or field worker in a kneeling position across a cultivated field which may contain fruit or berries to be harvested. The portion of the vehicle to support the worker in the kneeling position support the chest and abdomen of the worker. That support is connected to a throttle or rheostat whereby the speed of the vehicle can be controlled by varying the pressure on the support. By twisting this body against the throttle or rheostat control, the operator may apply more pressure on one side the and the other, cause the drive wheels to rotate faster on one side of the vehicle than the other, thereby steering the vehicle.

### SUMMARY

In one embodiment, an agricultural vehicle for picking berries and other low growing crops and tending low growing vegetation is disclosed. The vehicle comprises a chassis body having spaced apart first and second ends to define a length and spaced apart side portions to define a width. The chassis body has an aperture extending substantially the length between said first and second ends and said side portions substantially extending the width of said chassis body. The chassis body equipped with at least a first and second set of wheels; each wheel rotatably mounted on an axle orientable substantially transverse to the width of said chassis body. The first set of wheels are steering wheels, and the second set of wheels are drive wheels. The first set of wheels may be oriented in a collar affixed to said first end of said chassis body and said second set of wheels may be oriented adjacent the second end of the chassis body. The vehicle incudes a drive unit mounted to on or to the chassis body. The drive unit may be an electric motor (with at least one battery), fuel cell motor or an internal combustion engine (gasoline, natural gas or diesel) with attendant fuel tank. The drive unit is drivably connected to at least one drive wheel and is controllable by a throttle in the case of an internal combustion engine, or a rheostat controller, in the case of an electric or battery powered dive unit.

In one embodiment, the vehicle has an adjustable operator seat mounted on the chassis which is positioned along said chassis body length to permit height or position adjustment of the seat relative to the vegetation being tended so an operator may be seated in an upright, comfortable position and access the chassis body aperture. A shade canopy or weather cover may be mounted on said chassis body oriented along said chassis body to substantially protect an operator in the seat from the sun or rain.

The vehicle steering achieved by selective operation of the drive wheels. Specifically, the drive wheels each have a foot operated throttle pedal (if the drive unit is an internal combustion engine) or a foot operated rheostat or other electric control (if the drive unit is an electric motor). In addition, the vehicle may be equipped with hand operated throttle controls to selectively engage one or the other of the drive wheels.

In one embodiment, an operator applies foot pressure to the pedal (throttle or rheostat) to cause the drive wheels to rotate. When it is desired to turn the vehicle, the operator increases foot pressure on the pedal or rheostat on a first drive wheel while decreasing foot pressure on the throttle or rheostat that controls a second drive wheel. This causes the drive wheels to rotate at different rates. The front wheels are freely pivotable about the collar in which they are mounted. When one drive wheel rotates faster than the other drive wheel, the vehicle is turned. By explanation, if the right drive wheel rotates faster than the left drive wheel, the vehicle will turn left. If the left drive wheel rotates faster than the right drive wheel, the vehicle will turn right. Thus, the operator's hands are freed from controlling the vehicle as drive speed and turning is accomplished all by foot pressure on the pedals or rheostats.

In another embodiment, the operator may control the direction of the vehicle by operation of the hand throttles. When it is desired to turn the vehicle, the operator may use a and control throttle to activate one drive wheel or another, depending upon the direction desired. Just as in the case of the foot operated controls discussed above, when one drive wheel rotates faster than the other drive wheel, the vehicle is turned. By explanation, if the right drive wheel rotates faster than the left drive wheel, the vehicle will turn left. If the left drive wheel rotates faster than the right drive wheel, the vehicle will turn right. Thus, the operator's hands are feed from controlling the vehicle as drive speed and turning is accomplished all by foot pressure on the pedals or rheostats.

### BRIEF DESCRIPTION OF DRAWINGS

FIG. 1 is a perspective view of one embodiment of the vehicle showing its construction;

FIG. 2 is a perspective view of the vehicle of FIG. 1, showing the drive wheel throttle control;

FIG. 3 is another perspective view of the vehicle of FIG. 1, showing the foot throttle drive control.

FIG. 4 is another perspective view of the vehicle of FIG. 1, showing a rearward view of the foot throttle drive control.

### DETAILED DESCRIPTION

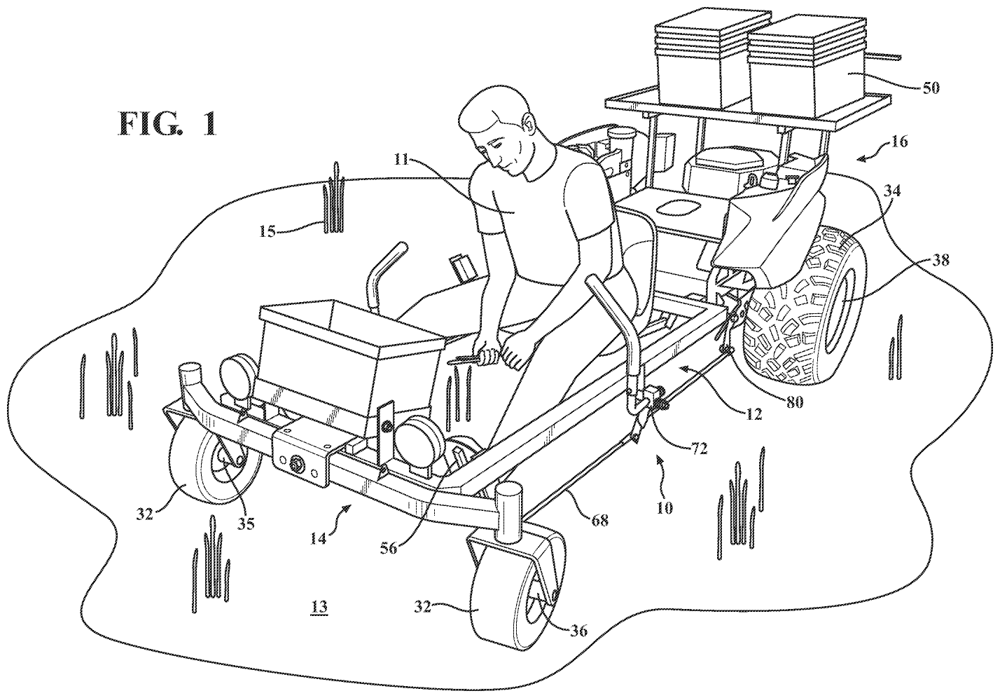

Turning now to the drawings wherein like numbers refer to like structures, There is disclosed as seen in FIG. 1 one embodiment of agricultural vehicle 10 in an asparagus field 13 with an operator 11 seated upright in an operator seat 26 harvesting asparagus 15. The vehicle has a chassis 12 with a front portion 14 and a rear portion 16 and two spaced apart substantially parallel side rails 18 and 20 to define an access space 22 there between. The front portion has a cross member 24 spanning between the side rails and the rear portion has a mounting surface 28 (which may be spaced apart cross members) separating the side rails. An operator seat 26 is mounted between the side rails toward the rear portion of the vehicle such that there is made an access 22 between the seat and the front portion through which the operator may gather berries or otherwise tend to low growing vegetation in a manner to be hereafter described. The operator seat may optionally be mounted between the rails on a rack 21 with pivots 27 to permit the seat to be adjusted up or down relative to the ground so the operator may comfortably adjust the seat relative to the ground vegetation, such as the asparagus 15, being tended. Rack 21 may also be adjustable in a forward backward direction to permit the seat to the adjusted to the size of the operator to permit the operator's legs to comfortable reach the throttle pedals. Optionally, the vehicle may be equipped with an occupant cover 30 which may be a canvas top 31 mounted on a frame 33 that is mounted onto the vehicle at mounts 29 to shade the occupant or provide some protection from the sun or inclement weather.

As shown in this embodiment, the vehicle has a first set of wheels 32 mounted in spaced apart relationship to each other at the front cross member and a second set of wheels 34 mounted in spaced apart relationship at the rear portion of the chassis. In this embodiment, the first set of wheels are steering wheels and the second set of wheels are the drive wheels. While shown having four wheels, it can be understood that the vehicle may be configured to have three wheels, such as two drive wheels and one steering wheel or one drive wheel and two steering wheels. Each set of wheels is rotatable mounted on axles 35, 36, 38 and 40 respectively, oriented substantially transverse and perpendicular to the chassis.

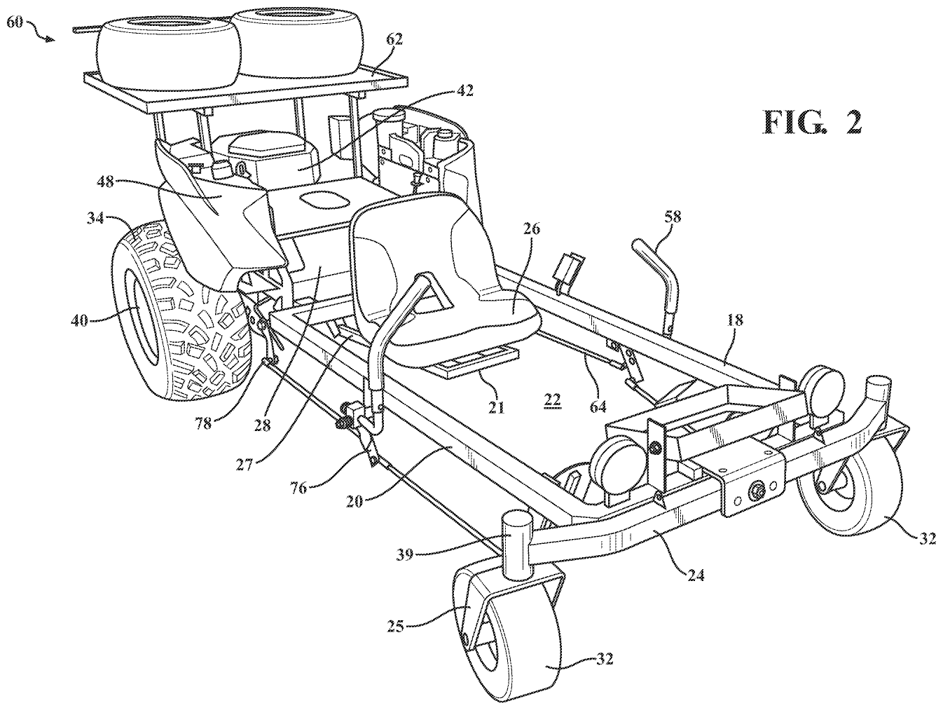

As seen in FIG. 2, each of the first set of wheels (front wheels) is joined at its axles to U mount 25 equipped with a central post 41 that is insertable into a collar 37 which is mounted transverse to and substantially perpendicular to the front member of the chassis. The collar may include bearings to accommodate the free rotation of the wheel about a 360 degree radius. A retaining pin or clip 43 is also contemplated to keep the front wheel in the collar.

In the embodiment as shown in FIG. 2, a drive unit 42 is provided that is mounted at the rear portion of the vehicle. The drive unit may be mounted by motor mounts to the vehicle frame as is well known in the art. Or the drive unit may be bolted directly to the frame. The drive unit may be an internal combustion engine (ICE) such as gasoline or diesel or natural gas. In case the drive unit is an ICE, there is a fuel storage tank 48 at the rear portion of the vehicle. While not shown, it is understood that in the case of an ICE, a fuel pump, and other parts normally attendant to the operation of the ICE are also included within the term dive unit.

In another embodiment, the drive unit may be an electric motor. The electric drive unit may be powered by a fuel cell or Lithium Ion Battery, Lead Acid Battery or any other battery 50 (as seen in FIG. 1) or other suitable power source mounted in the rear of the vehicle. The drive unit is drivably connected to each drive wheel at the rear of the vehicle. If the drive unit is an electric motor, it is contemplated that the drive unit may be two electric or fuel cell motors, each separately drivable connected to a separate drive wheel. In case the drive unit is an ICE, or a single electric motor, a transmission 52 is interposed between the drive unit and the drive wheels so that it is possible to control each drive wheel separately. The dive unit may be surrounded by storage space 60 that includes shelves 62 for storing spare tires or the like.

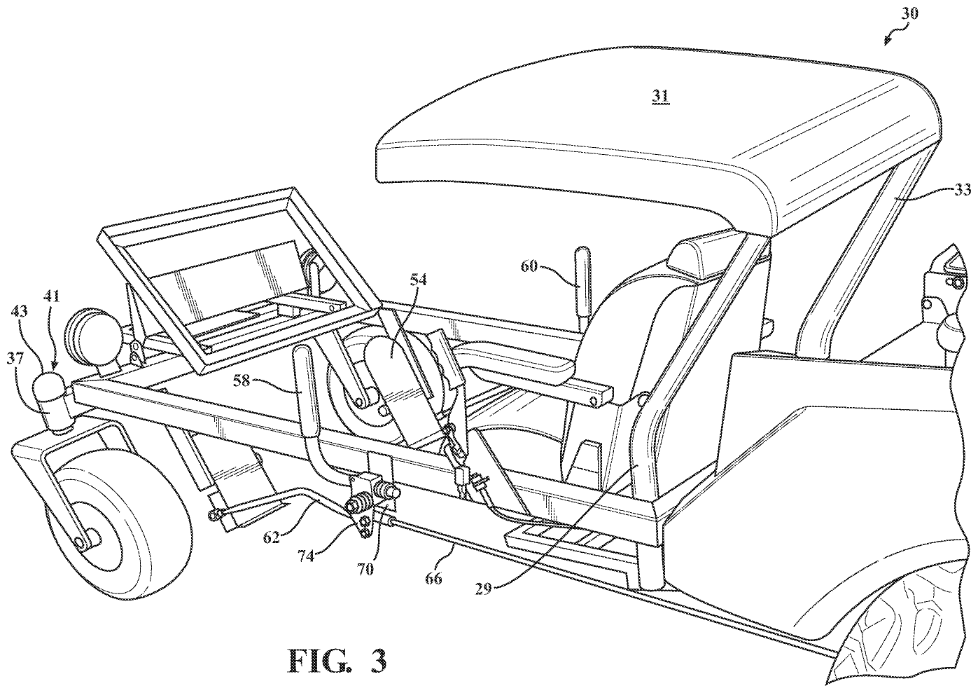

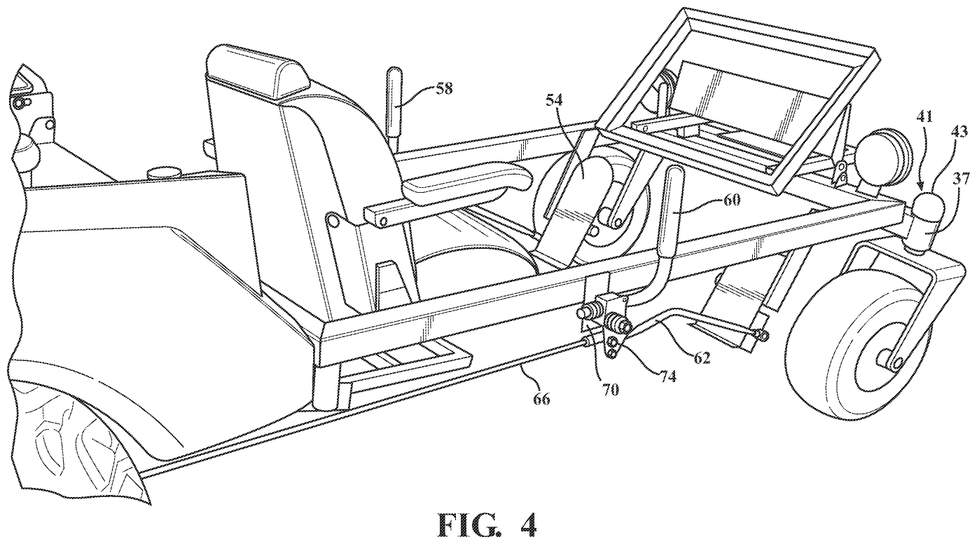

In one embodiment, a foot operated throttle pedal (for an ICE) or rheostat or switch (for electric drive unit) 54 as seen in FIGS. 3 and 4 is mounted on each side rail such that there may be two foot operated throttle pedals or two rheostat or switches for the control of the vehicle drive unit. When the operator desires the vehicle to move linearly, an equal amount of foot pressure is applied to each throttle pedal (or rheostat or other suitable switch) and the drive unit engages both drive wheels such that the drive wheels each rotate at the same rate, thereby driving the vehicle in a more or less straight line. When the operator wishes to turn the vehicle, unequal pressure is applied to the pedal or rheostat. For example, if the pedal on the right is pressed and the pedal on the left is not, the vehicle drive unit engages the drive wheel on the left and causes it to rotate faster than the wheel on the right. This causes the vehicle to turn to the left. When it is desired to turn the vehicle to the left, the right throttle or rheostat is depressed and the left throttle or rheostat is not actuated, thereby causing the right drive wheel to rotate faster than the left drive wheel causing the vehicle to turn left. The front wheels, being unpowered and freely rotatable, swivel in the collar and cause the vehicle to travel in the direction dictated by the drive wheel rotation. This arrangement permits the vehicle to have a “zero radius” turning ability which is especially useful when navigating rows of planted crops.

In another embodiment, as seen in FIGS. 3 and 4, hand throttles 58 and 60 are pivotally mounted to the frame members at pivots 70, 72 respectively. Drive linkages 62 and 64 are pivotally connected to a flanges 74 and 76 by the hand throttles and pivotally connected at 78, 80 to the drive unit. Activation of the hand throttles engages the drive unit wheels selectively, depending upon how must the throttle handle is pushed or pulled by the operator 11 about the pivots 70, 72. Similarly, the hand throttle may operate as a hand steering mechanism to turn the first set of wheels 32 right or left depending upon which hand throttle is activated. It can be seen that operation of the right side hand throttle operates the right front wheel and the operation of the left hand throttle control can operate the left front wheel 32.

In each embodiment as described, the advantages to be had with a vehicle of this type are made apparent. The operator may adjust the operator seat with seat adjuster 21 to sit in a natural position, and operates the vehicle with the foot pedals (throttles) or, optionally hand throttles. The access space between the rails permits the operator to pass over the low lying vegetation to be picked or plant to be tended, and reach through the access space to pick only that vegetation that is ripe, or to tend only those plants that require tending. Instead of being in a prone position during the operation, the operator is in a naturally seated position. This permits greater comfort and ease of operation as well as greater efficiency as the operator is not subjected to being placed in a kneeling or prone position for extended periods of time while tending the corps. Moreover, the vehicle is easily operated as the operator can view the direction of desired travel.

Accordingly, it is to be understood that the above description is intended to be illustrative and not restrictive. Many embodiments and applications other than the examples provided would be apparent upon reading the above description. The scope of the invention should be determined with reference to the appended claims along with the full scope of equivalents to which such claims are entitled. It is anticipated and intended that future developments will occur, and that the disclosed systems and processes will be incorporated into such future embodiments. The invention is capable of modification and variation.

All terms used in the claims are intended to be given their broadest reasonable constructions and their ordinary meanings as understood by those knowledgeable in the technologies described herein unless an explicit indication to the contrary is made herein. Use of the singular articles such as “a,” “the,” “said,” recite one or more of the indicated elements unless a claim recites an explicit limitation to the contrary.

I claim:

1. An agricultural vehicle, comprising:
a chassis body having spaced apart side portion rails with first and second ends to define a length and width;
said chassis body having an aperture extending substantially the length between said first and second ends and said side portion rail substantially extending the width of said chassis body;
said chassis body equipped with at least a first and second set of wheels; each wheel rotatably mounted on an axle orientable substantially transverse to the width of said chassis body; said first set of wheels being steering wheels, said second set of wheels being drive wheels, said first set of wheels oriented adjacent the first end in a collar affixed to said first end of said chassis body and said second set of wheels oriented adjacent said second end of said chassis body;
a drive unit mounted to said chassis body; said drive unit separately drivably connected to said drive wheels; said drive unit controllable by at least one throttle controller;
an operator seat mounted on said chassis; said seat positioned along said chassis body length toward said rear portion to permit an operator to be seated in an upright position and access said chassis body aperture; and
at least one steerable front wheel.

2. The agricultural vehicle of claim 1, wherein said drive unit is connectable to at least two drive wheels mounted at the front or rear portion of said vehicle; each said drive wheel operable by a separate foot operable controller; each said foot operable controller mounted on opposing side portions and operable by an operator to apply variable rotational drive to each drive wheel.

3. The agricultural vehicle of claim 1, wherein said vehicle includes two steerable wheels mounted at the front of said vehicle.

4. The agricultural vehicle of claim 1, further including a canopy mounted relative to said operator seat to provide shade to said operator while seated in said seat.

5. The agricultural vehicle of claim 1, wherein said throttle controller is a throttle pedal and said drive unit is an internal combustion engine.

6. The agricultural vehicle of claim 1, wherein the drive unit is an electric motor and said throttle controller is a rheostat.

7. The agricultural vehicle of claim 1, further including a seat rack wherein the seat is adjustable.

8. The agricultural vehicle of claim 1, further including a hand throttle pivotally mounted to each said side portion rail; each said hand throttle controlling a drive linkage to each said drive wheel and a steering linkage controlling each steerable wheel.

9. The agricultural vehicle of claim 1, wherein the drive unit is an internal combustion engine.

10. An agricultural vehicle, comprising:
a chassis including a frame having a length and a width; said frame including a space apart front portion and a rear portion, said frame having spaced apart substantially parallel first and second side rails extending substantially the length of the frame; and first and second cross members extending between said spaced apart side rails in spaced apart relation to each other; said first cross member attached at said front portion and equipped with at least one wheel pivotally attached to said frame substantially at said front portion; said second cross member attached at substantially said rear portion of said frame; said second cross member having two drive wheels rotatably attached thereto; a drive unit mounted on said chassis at said rear portion; said drive unit independently drivably connected to each said drive wheel;
an operator seat mounted on a seat rack between said front and rear portion; and
first and second drive unit controllers; said first drive unit controller mounted to said first side rail and said second drive unit controller mounted on said second rail; said drive unit controllers mounted on said side rails substantially proximal to said front portion of said frame and operable by an operator seated in said seat.

11. The agricultural vehicle of claim 10, further including a weather cover mounted on said vehicle relative to said operator seat to provide shade to said operator while seated in said seat.

12. The agricultural vehicle of claim 10, wherein the drive motor unit is an internal combustion engine and said first and second drive unit controllers are throttle pedals mounted on said side rails and operable by an operator foot while seated in said seat.

13. The agricultural vehicle of claim 10, wherein the drive motor unit is an electric motor and said first and second drive unit controllers are rheostats or switches mounted on said side rails and operable by an operator while seated in said seat.

14. The agricultural vehicle of claim 1, wherein said seat rack is adjustable to position said seat.
